(19) United States
(12) Patent Application Publication
(10) Pub. No.: US 2015/0307775 A1
(43) Pub. Date: Oct. 29, 2015

(54) METHOD OF PREPARING A COMPOSITE ARTICLE AND COMPOSITE ARTICLE

(71) Applicant: Dow Corning Corporation, Midland, MI (US)

(72) Inventors: James Allen Casey, Merrill, MI (US); Susan Victoria Perz, Essexville, MI (US); Charles Serrano, Midland, MI (US); David Lawrence Witker, Bay City, MI (US)

(21) Appl. No.: 14/669,196

(22) Filed: Mar. 26, 2015

Related U.S. Application Data
(60) Provisional application No. 61/971,252, filed on Mar. 27, 2014.

(51) Int. Cl. C09K 11/59; C04B 40/00; C09K 11/02; C04B 35/14

(52) U.S. Cl. CPC C09K 11/59; C04B 35/14; C04B 40/0007; C09K 11/025

(57) ABSTRACT

A method of preparing a composite article and the composite article prepared thereby are disclosed. The method comprises combining a precursor compound and nanoparticles produced via a plasma process to form a composition. The method further comprises forming the composite article from the composition. The composite article comprises a host matrix comprising SiO_{4/2} units with the nanoparticles dispersed in the host matrix.

### CROSS REFERENCE TO RELATED APPLICATIONS

This application claims priority to and all advantages of U.S. Patent Application No. 61/971,252, filed on Mar. 27, 2014, the content of which is hereby incorporated by reference.

### FIELD OF THE INVENTION

The present invention generally relates to a method of preparing a composite article and, more specifically, to a method of preparing a composite article from a composition and to a composite article comprising a host matrix comprising SiO_{4/2} units and nanoparticles dispersed in the host matrix.

### DESCRIPTION OF THE RELATED ART

Nanoparticles are known in the art and can be prepared via various processes. For example, nanoparticles are often defined as particles having at least one dimension of less than 100 nanometers and are produced either from a bulk material, which is initially larger than a nanoparticle, or from particles smaller than the nanoparticles, such as ions and/or atoms. Nanoparticles are particularly unique in that they may have significantly different properties than the bulk material or the smaller particles from which the nanoparticles are derived. For example, a bulk material that acts as an insulator or semiconductor can be, when in nanoparticle form, electrically conductive.

One method of producing nanoparticles starting with the bulk material is attrition. In this method, the bulk material is disposed in a mill, thereby reducing the bulk material to nanoparticles and other larger particles. The nanoparticles can be separated from the other larger particles via air classification.

Nanoparticles have also been produced by laser ablation utilizing a pulsed laser. In laser ablation, bulk metals are placed in aqueous and/or organic solvents and the bulk metals are exposed to the pulsed laser (e.g. copper vapor or neodymium-doped yttrium aluminum garnet). The nanoparticles are ablated from the bulk metal by laser irradiation and subsequently form a suspension in the aqueous and/or organic solvents. However, the pulsed laser is expensive and, additionally, the nanoparticles produced from laser ablation are typically limited to metal nanoparticles.

### SUMMARY OF THE INVENTION

The present invention provides a method of preparing a composite article. The method comprises combining a precursor compound and nanoparticles produced via a plasma process to form a composition. The method further comprises forming the composite article from the composition. The composite article comprises a host matrix comprising SiO_{4/2} units formed from the precursor compound with the nanoparticles being dispersed in the host matrix.

The present invention also provides a composite article formed in accordance with the method.

Finally, the present invention provides a composite article. The composite article comprises a host matrix comprising SiO_{4/2} units. The composite article further comprises nanoparticles dispersed in the host matrix, the nanoparticles being produced via a plasma process.

### BRIEF DESCRIPTION OF THE DRAWINGS

Other advantages and aspects of this invention may be described in the following detailed description when considered in connection with the accompanying drawings wherein:

FIG. 1 illustrates one embodiment of a low pressure high frequency pulsed plasma reactor for producing nanoparticles;

FIG. 2 illustrates another embodiment of a low pressure high frequency pulsed plasma reactor for producing nanoparticles;

FIG. 3 illustrates an embodiment of a system including a low pressure pulsed plasma reactor to produce nanoparticles and a diffusion pump to collect the nanoparticles; and

FIG. 4 illustrates a schematic view of one embodiment of a diffusion pump for collecting nanoparticles produced via a reactor.

### DETAILED DESCRIPTION OF THE INVENTION

The present invention provides a method of preparing a composite article and the composite article formed thereby. The present invention additionally provides a composite article that need not be formed by the method. The composite article of the invention has excellent physical properties and is suitable for use in numerous different applications and end uses.

The method comprises combining a precursor compound and nanoparticles produced via a plasma process to form a composition. The method further comprises forming the composite article from the composition. The composite article comprises a host matrix comprising SiO_{4/2} units with the nanoparticles dispersed in the host matrix.

The precursor compound is generally utilized to form the SiO_{4/2} units of the host matrix. As readily understood in the art, SiO_{4/2} units are alternatively referred to as Q units, or silica. To this end, the host matrix generally comprises siloxane bonds (Si—O—Si), although carbon-carbon bonds may also be present in host matrix, particularly as divalent linking groups between silicon atoms. The host matrix is described in greater detail below.

The particular precursor compound utilized in the composition may be any precursor compound suitable for forming SiO_{4/2} units.

In certain embodiments, the precursor compound comprises a silane compound. In these embodiments, the host matrix is typically formed in situ in the presence of the nanoparticles. The silane compound generally includes a central silicon atom having four substituents bonded thereto. The substituents are typically hydrolyzable groups or hydrolyzates of hydrolyzable groups. For example, hydrolyzable groups are understood in the art to undergo hydrolysis in the presence of water to form silanol (Si—OH) groups. The silanol groups may then condense to form siloxane bonds with water as a by-product. Examples of hydrolyzable groups include silicon-bonded hydrogen atoms, silicon-bonded halogen atoms, silicon-bonded alkoxy groups, silicon-bonded alkylamino groups, silicon-bonded carboxy groups, silicon-bonded alkyliminoxy groups, silicon-bonded alkenyloxy groups, and silicon-bonded N-alkylamido groups. The silane compound may comprise a silicon alkoxide monomer, a silicon ester monomer, or any partially hydrolyzed and/or partially condensed compound thereof, or any mixture thereof.

In one specific embodiment, the precursor compound comprises an alkoxy-functional silane. In this embodiment, the precursor compound has the general formula (1):

Si(OR)₄ (1),

where each R is an independently selected hydrocarbyl group having from 1-20, alternatively from 1-10, alternatively from 1-4, carbon atoms. Specific examples of alkoxy-functional silanes within general formula (1) include tetramethyl orthosilicate (or tetramethoxysilane), tetraethyl orthosilicate (or tetraethoxysilane), tetrapropyl orthosilicate (or tetrapropoxysilane), and tetrabutyl orthosilicate (or tetrabutoxysilane). Notably, in each of these specific examples provided each R has the same number of carbon atoms. However, R may be independently selected. For example, the precursor compound may comprise two silicon-bonded methoxy groups and two silicon-bonded ethoxy groups. In this embodiment, the method of forming the host matrix from the precursor compound may alternatively be referred to as a sol-gel method.

The alkoxy-functional silane of general formula (1) may be utilized with other precursor compounds or other alkoxy-functional silanes. For example, alkyltrialkoxysilanes, which include three silicon-bonded alkoxy groups instead of four, may be utilized along with the alkoxy-functional silane of general formula (1). Similarly, dialkyldialkoxysilanes and/or trialkylmonoalkoxysilanes may be utilized. It is also to be appreciated that any of the hydrolyzable groups set forth above may independently be utilized in lieu of any alkoxy groups of the alkoxy-functional silane of general formula (1) as the precursor compound.

The precursor compound may alternatively comprise any partially hydrolyzed and/or partially condensed form of the silane compound. For example, the silane compound may partially hydrolyzed and condensed so as to form an oligomeric or polymeric compound, which is still within the scope of the instant precursor compound.

In embodiments where the precursor compound comprises the silane compound, the composition generally further comprises a catalyst. For example, in certain embodiments, the catalyst may be a basic catalyst or an acidic catalyst, as the sol-gel method may be acid catalyzed or base catalyzed. As such, it is desirable to generally impart alkalinity or acidity to the composition. Examples of adds for imparting acidity to the composition include inorganic acids, such as hydrochloric acid, sulfuric acid and nitric acid; and organic acids, such as formic acid, acetic acid and propionic acid. Examples of bases for imparting alkalinity to the composition include conventional bases, such as sodium hydroxide, as well as quaternary ammonium hydroxides, such as tetramethylammonium hydroxide, tetraethylammonium hydroxide and tetrapropylammonium hydroxide.

The composition may optionally be stabilized with the aid of a stabilizing additive, such as non-ionic, cationic, and/or anionic polymers, or any other stabilizing additive known to one of skill in the art. Specific examples of cationic surfactants include alkylammoniums, dialkylammoniums, trialkylammoniums, benzylammonium and alkylpiridiniums. Specific examples of anionic surfactants include alkyl sulfate ions and alkylphosphate ions. Specific examples of non-ionic surfactants include polyalkylene oxides, block copolymers thereof and alkylamines.

Quaternary ammonium compounds may also be utilized in the composition. Such quaternary ammonium compounds may act as a surfactant in the composition and/or may serve as a phase-transfer catalyst. For example, the quaternary ammonium compounds may have the general formula (H):

[NR¹R²R³R⁴]⁺ (II)

(wherein R¹ is a hydrocarbyl group having 1 to 36 carbon atoms, and R² to R⁴ are each independently selected alkyl groups having 1 to 6 carbon atoms). Specific examples of the quaternary ammonium compounds represented by the general formula (II) include cations such as hexadecyltrimethylammonium, dodecyltrimethylammonium, benzyltrimethylammonium, dimethyldidodecylammonium and hexadecylpiridinium. Corresponding salts may also be utilized. For example, a counterion, i.e., an anion, may be present along with the quaternary ammonium compounds of general formula (II). The counterion may be, for example, chlorine, in which case the quaternary ammonium compound is a quaternary ammonium chloride.

When the precursor compound comprises the silane compound, the composition generally further comprises water. Water may serve as both a solvent in the composition and hydrolyzes the silane compound. If desired, the composition may further comprise a solvent other than water, such as an alcohol. Examples of alcohols include methanol, ethanol, n-propanol, 2-propanol, n-butanol, sec-butanol, t-butanol, allylalcohol, cyclohexanol and benzyl alcohol, diols and mixtures thereof.

In this embodiment, the precursor compound of the composition hydrolyzes and condenses to form the host matrix comprising SiO_{4/2} units. For example, when the precursor compound has the general formula (1) above, the precursor compound reacts according to the following reaction mechanism:

Si(OR)₄+2H₂O→SiO₂+4ROH.

R is defied above. An alcohol corresponding to R of the silane compound results as a byproduct. As readily understood in the art, the terminology “SiO_{4/2} units” is a different form of nomenclature for representing SiO₂.

As understood in the art, in these embodiments, the relative amounts of the precursor compound (when the precursor compound has the general formula (1) above), water, and any catalyst may vary based on a desired morphology of the host matrix. For example, water may be utilized in molar excess to the precursor compound to ensure the precursor compound fully reacts.

In other embodiments, the precursor compound comprises a large molecule, which is distinguished from the silane compound, which is typically monomeric (unless partially hydrolyzed/condensed). The large molecule may be any large molecule capable of forming the host matrix comprising SiO_{4/2} units. Generally, SiO_{4/2} units are formed from condensing silanol groups.

In one embodiment in which the precursor compound comprises the large molecule, the precursor compound comprises a silicone resin, e.g. a silsesquioxane resin. Silsesquioxane resins are known in the art and generally have a cage-like structure, which may be in the form of, for example, a cube, a hexagonal prism, an octagonal prism, a decagonal prism, a dodecagonal prism, etc. Silsesquioxane resins may alternatively be referred to as T resins, as silsesquioxane resins generally comprise, consist essentially of, or consist of T units (i.e., R⁵SiO_{3/2} units, where R⁵ is an independently selected hydrocarbyl group or a hydrogen atom).

The silsesquioxane resin may additionally comprise M, D, and/or Q units. M units have the general formula R⁵₃SiO_{1/2}; D units have the general formula R⁵₂SiO_{2/2}; and Q units have the general formula SiO_{4/2}. R⁵ is defined above. However, the silsesquioxane resin typically predominately comprises T units. The T units are generally H or OH functional (or terminated), which may condense and crosslink to form Q units in the host matrix, as described below.

In certain embodiments, the silsesquioxane resin comprises a hydrogen silsesquioxane resin. In these embodiments, one or more of the T units of the silsesquioxane resin includes a silicon-bonded hydrogen atom, i.e., at least one R⁵ is a hydrogen atom. In these or other embodiments, the silsesquioxane resin includes a plurality of hydrolyzable groups or hydrolyzates of hydrolyzable groups. Examples of hydrolyzable groups are set forth above. Typically, the silsesquioxane resin comprises a plurality of silanol (Si—OH) groups. Although other hydrolyzable groups may be hydrolyzed to form the silanol groups, because of stearic hindrance, it is preferable that the silsesquioxane resin comprises the plurality of silanol groups as opposed to other hydrolyzable groups, although other hydrolyzable groups may be present along with or in lieu of the plurality of silanol groups. The silanol groups of the silsesquioxane resin may condense to form siloxane bonds and thus the T units of the silsesquioxane resin may be converted to SiO_{4/2} units. Depending on the silsesquioxane resin, any proportion of the T units may be converted to SiO_{4/2} units, e.g. at least 10, alternatively at least 20, alternatively at least 30, alternatively at least 40, alternatively at least 50, alternatively at least 60, alternatively at least 70, alternatively at least 80, alternatively at least 90, mole percent of all T units in the silsesquioxane resin may be converted to SiO_{4/2} units.

In embodiments where the precursor compound comprises the silsesquioxane resin, the composition typically further comprises a vehicle. The vehicle may be a carrier solvent or any vehicle capable of substantially solubilizing or otherwise dispersing the silsesquioxane resin. Typically, the vehicle is an organic solvent, such as methyl isobutyl ketone. Alternatively, the carrier vehicle may comprise volatile silicone compounds, such as cyclic siloxanes (e.g. D4) and/or hexamethyldisilazane (HDMS).

As introduced above, the method comprises combining the precursor compound and the nanoparticles to form the composition.

Combining the precursor compound and the nanoparticles may be carried out in any manner. As set forth above, the composition may optionally comprise a solvent (and/or water). The solvent may be present with the precursor compound and/or the nanoparticles at the time of preparing the composition. Generally speaking, when the precursor compound comprises the silane compound, the silane compound is not combined with water to form the composition until immediately before the step of forming the composite article, as water may prematurely react with the precursor compound upon their combination. The nanoparticles may be collected in a solvent at the time of their production, and subsequently combined with the precursor compound to form the composition, either neat or along with the solvent. Depending on a viscosity of the composition, combining the precursor compound and the nanoparticles may further comprise mixing the precursor compound and the nanoparticles. For example, the precursor compound and the nanoparticles may be blended, such as by hand, by mechanical mixing, by sonication, etc. When the composition is sufficiently viscous, the composition may be compounded so as to blend the nanoparticles and the precursor compound prior to or during forming the composite article.

The manner by which the composite article is formed from the composition is generally selected based on the precursor compound utilized in the composition.

For example, in the first embodiment described above where the precursor compound comprises the silane compound, the composite article may be formed upon forming the composition. In particular, the silane compound reacts over time via hydrolysis and/or condensation to form the host matrix while the silane compound is in the presence of water and optionally the catalyst. The silane compound generally reacts over time even in the absence of conventional curing conditions, such as heat, electromagnetic radiation, etc. As such, in this embodiment, the composition is generally mixed (e.g. by stirring) so as to disperse the nanoparticles in the composition, which leads to improved dispersion of the nanoparticles in the composite article. The composition may optionally be placed in a mold or disposed in any vessel or on any substrate for forming the composite article. The composition is generally allowed to stand at ambient conditions while the silane compound reacts to form the host matrix. As noted above, an alcohol results as the by-product as the formation of the host matrix from the silane compound. Alcohol may evaporate over time, or the composition and/or the composite article may be heated so as to drive the alcohol therefrom. Similarly, excess water may be present in the composition and/or the composite article. Water may be removed via a variety of methods, such as evaporation, heating, and/or freeze-drying.

Alternatively, in the second embodiment described above in which the precursor compound comprises the silsesquioxane resin, a curing condition is typically applied to the composition to form the composite article. In particular, in certain embodiments, the curing condition is heating the composition. Heating serves a dual purpose to drive any solvent from the composition and/or composite article and to initiate condensation of the silicon-bonded hydroxy groups (i.e., silanol groups) in the silsesquioxane resin. More specifically, heat is typically applied to the composition to form the composite article from the composition. If desired, the composition may be mixed (e.g. by stirring) so as to disperse the nanoparticles in the composition, which leads to improved dispersion of the nanoparticles in the composite article. The composition may optionally be placed in a mold or disposed in any vessel or on any substrate for forming the composite article.

When the curing condition comprises heating, the composition is generally heated at a desired temperature for a period of time. The desired temperature and the period of time are generally selected so as to ensure curing of the silsesquioxane resin and to drive any solvent from the composition and/or the composite article. One of skill in the art can readily determine the optimal desired temperature and period of time based on the particular silsesquioxane resin utilized and the physical properties of any solvent in the composition. In certain embodiments, the desired temperature is from 50 to 600, alternatively from 100 to 400, ° C. The period of time is generally selected based on the desired temperature, with lesser periods of time required for higher temperatures. Longer periods of time also generally increase the number of SiO_{4/2} units within the host matrix. If desired, the desired temperature may be cycled or increased as various increments to ensure curing of the silsesquioxane resin. Further, if desired, lesser temperatures may be initially utilized to drive solvent from the composition, while greater temperatures are subsequently utilized to cure the silsesquioxane resin of the composition.

Depending on the particular precursor compound utilized to form the host matrix of the composite article, the composite article may have various forms. For example, most typically, the composite article is a solid. However, the composite article may be flowable, e.g. the composite article may be in the form of a gel or other highly viscous material. Alternatively still, the composite article may be in the form of flakes or a powder.

The present invention also provides the composite article. The composite article comprises the host matrix and nanoparticles dispersed in the host matrix, with the nanoparticles being produced via a plasma process, as described below. The composite article may be prepared via the method or via other methods not specifically disclosed herein. The composite article may have various forms and shapes. For example, the composite article may be a slab, a film, a cone, a powder, etc. and the composite article may be solid or flowable, as introduced above. The composite article may be formed on a substrate, such as a release liner, that is optionally separable from the composite article once formed. The composite article generally has excellent physical properties, including luminescence when the nanoparticles dispersed therein are photoluminescent. Further, the composite article may be optically transparent. For example, in certain embodiments, the composite article has a light transmittance of at least 90, at least 95, at least 96, at least 97, at least 98, or at least 99, percent, as determined in accordance with ASTM D1003. The composition utilized to form the composite article and the composite article formed therefrom may have similar or different light transmittance values.

The relative amounts of the nanoparticles in the composition and the composite article may vary based on a variety of factors and considerations. For example, the relative amount of the nanoparticles may vary even from the composition to the composite article in embodiments where the composition comprises a solvent. Of course, in these embodiments, the concentration of nanoparticles increases in the composite article as compared to the composition. Similarly, the desired physical properties of the composite article, e.g. photoluminescent intensity, may drive the concentration of the nanoparticles in the composition and/or the composite article.

In certain embodiments, the composition comprises the nanoparticles in an amount of from 0.0001 to 80, alternatively from 0.01 to 50, alternatively from 0.1 to 25, percent by weight based on the total weight of the composition. This is also true in various embodiments with respect to the composite article.

Independent of the method by which the composite article is formed, the composite article comprises the host matrix comprising SiO_{4/2} units with the nanoparticles being dispersed in the host matrix. In certain embodiments, the composite article consists essentially of, alternatively consists of, the host matrix and the nanoparticles. The host matrix generally has an Si to O ratio of at least 3:1; alternatively at least 3.1:1; alternatively at least 3.2:1; alternatively at least 3.3:1; alternatively at least 3.4:1; alternatively at least 3.5:1. The host matrix may additionally comprise T units, D units, and/or M units. Generally, the host matrix predominately comprises Q units and T units. The host matrix may alternatively be referred to as a silica host matrix.

Regardless of the type of composition utilized to form the composite article, the composition, as well as the composite article formed therefrom, further comprises nanoparticles, as introduced above. The nanoparticles of the composition are produced via a plasma process. As readily understood in the art, the process by which nanoparticles are produced generally impacts the physical properties and characteristics of the resulting nanoparticles. In various embodiments, the nanoparticles are MH-functional nanoparticles, where M being an independently selected Group IV element. As used herein, the group designations of the periodic table are generally from the CAS or old IUPAC nomenclature, although Group IV elements are referred to as Group 14 elements under the modern IUPAC system, as readily understood in the art.

In various embodiments, the nanoparticles of the composition are produced via an RF plasma-based process. In these embodiments, a constricted RF plasma may be utilized to produce the nanoparticles. More specifically, these processes utilize an RF plasma operated in a constricted mode to produce nanoparticles from a precursor gas.

In these embodiments, the process of producing the nanoparticles may be carried out by introducing a precursor gas and, optionally, a buffer gas into a plasma chamber and generating an RF capacitive plasma in the chamber. The RF plasma may be created under pressure and RF power conditions that promote the formation of a plasma instability (i.e., a spatially and temporally strongly non-uniform plasma) which causes a constricted plasma to form in the chamber. The constricted plasma, sometimes also referred to as contracted plasma, leads to the formation of a high-plasma density filament, sometimes also referred to as a plasma channel. The plasma channel is characterized by a strongly enhanced plasma density, ionization rate, and gas temperature as compared to the surrounding plasma. It can be either stationary or non-stationary. Periodic rotations of the filament in the discharge tube may be observed, e.g. the filament may randomly change its direction of rotation, trajectory and frequency of rotation. The filament may appear longitudinally non-uniform, or striated. In other cases, the filament may be longitudinally uniform.

An inert buffer or carrier gas, such as neon, argon, krypton or xenon, may desirably be included with the precursor gas. The inclusion of such gases in the constricted plasma-based methods is particularly desirable because these gases promote the formation of the thermal instability to achieve the thermal constriction. In the RF plasmas, dissociated precursor gas species (i.e., the dissociation products resulting from the dissociation of the precursor molecules) nucleate and grow into nanoparticles.

It is believed that the formation of a constricted RF plasma promotes crystalline nanoparticle formation because the constricted plasma results in the formation of a high current density current channel (i.e., filament) in which the local degree of ionization, plasma density and gas temperature are much higher than those of ordinary diffuse plasmas which tend to produce amorphous nanoparticles. For example, in some instances gas temperatures of at least about 1000 K with plasma densities of up to about 10¹³ cm⁻³ may be achieved in the constricted plasma. Additional effects could lead to further heating of the nanoparticles to temperatures even higher than the gas temperature. These include recombination of plasma electrons and ions at the nanoparticle surface, hydrogen recombination at the particle surface and the condensation heat release related to nanoparticle surface growth. In some instances the nanoparticles may be heated to temperatures several hundred degrees Kelvin above the gas temperature. The plasma may be continuous, rather than a pulsed plasma.

Thus, some embodiments of the present processes use an RF plasma constriction to provide high gas temperatures using relatively low plasma frequencies.

Conditions that promote the formation of a constricted plasma may be achieved by using sufficiently high RF powers and gas pressures when generating the RF plasma. Any RF power and gas pressures that result in the formation of a constricted RF plasma capable of promoting nanoparticle formation from dissociated precursor gas species may be employed. Appropriate RF power and gas pressure levels may vary somewhat depending upon the plasma reactor geometry. However, in one illustrative embodiment of the processes provided herein, the RF power used to ignite the RF plasma is at least about 100 Watts and the total pressure in the plasma chamber in the presence of the plasma (i.e., the total plasma pressure) is at least about 1 Torr. This includes embodiments where the RF power is at least about 110 Watts and further includes embodiments where the RF power is at least about 120 Watts. This also includes embodiments where the total pressure in the plasma chamber in the presence of the plasma is at least about 5 Torr and further includes embodiments where the total pressure in the plasma chamber in the presence of the plasma is at least about 10 Torr (e.g. from about 10 to 15 Torr).

Conditions that promote the formation of a non-constricted RF plasmas may be similar to those described above for the production of constricted plasmas. However, nanoparticles are generally formed in the non-constricted plasmas at lower pressures, higher precursor gas flow rates, and lower buffer gas flow rates. For example, in some embodiments, the nanoparticles are produced in an RF plasma at a total pressure less than about 5 Torr and, desirably, less than about 3 Torr. This includes embodiments where the total pressure in the plasma reactor in the presence of the plasma is about 1 to 3 Torr. Typical flow rates for the precursor gas in these embodiments may be at least 5 sccm, including embodiments where the flow rate for the precursor gas is at least about 10 sccm. Typical flow rates for buffer gases in these embodiments may be about 1 to 50 sccm.

The frequency of the RF voltage used to ignite the radiofrequency plasmas may vary within the RF range. In certain embodiments, a frequency of 13.56 MHz is employed, which is the major frequency used in the RF plasma processing industry. However, the frequency may desirably be lower than the microwave frequency range, i.e., lower than about 1 GHz. This includes embodiments where the frequency will desirably be lower than the very high frequency (VHF) range (e.g. lower than about 30 MHz). For example, the present methods may generate radiofrequency plasmas using radiofrequencies of 25 MHz or less.

Additional aspects relating to this particular embodiment in which the nanoparticles are produced via this plasma process are described in U.S. Pat. No. 7,446,335 and U.S. Pat. No. 8,016,944, which are each incorporated by reference herein in their respective entireties.

In other embodiments, the nanoparticles of the composition are prepared in a low pressure plasma reactor, such as a low pressure high frequency pulsed plasma reactor.

In these embodiments, pulsing the plasma enables an operator to directly set the resident time for particle nucleation and thereby control the particle size distribution and agglomeration kinetics in the plasma. For example, the operating parameters of the pulsed reactor may be adjusted to form crystalline nanoparticles or amorphous nanoparticles. Semiconductor containing precursors enter into the dielectric discharge tube where the capacitively coupled plasma, or inductively coupled plasma, is operated. Nanoparticles start to nucleate as the precursor molecules are dissociated in the plasma. When the plasma is off, or in a low ion energy state, during the pulsing cycle, the charged nanoparticles can be evacuated to the reactor chamber where they may be deposited on a substrate or subjected to further processing.

The power may be supplied via a variable frequency radio frequency power amplifier that is triggered by an arbitrary function generator to establish the high frequency pulsed plasma. In one embodiment, the radiofrequency power is capacitively coupled into the plasma using a ring electrode, parallel plates, or an anode/cathode setup in the gas. Alternatively, the radiofrequency power may be inductively coupled mode into the plasma using an RF coil setup around the discharge tube. The precursor gases can be controlled via mass flow controllers or calibrated rotometers. The pressure differential from the discharge tube to the reactor chamber can be controlled through a changeable grounded or biased orifice. Depending on the orifice size and pressures, the nanoparticle distributions into the reactor chamber may change, thus providing another process parameter that can be used to adjust the properties of the resulting nanoparticles.

In one embodiment, the plasma reactor may be operated in the frequency from 10 MHz to 500 MHz at pressures from 100 mTorr to 10 Torr in the discharge tube and powers from 5 watts to 1000 watts.

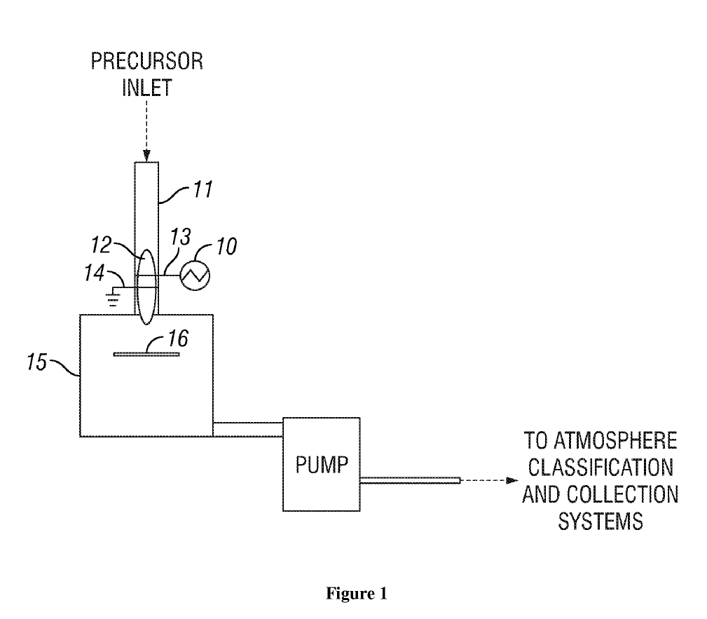

Referring now to FIG. 1, one exemplary embodiment of a low pressure high frequency pulsed plasma reactor is shown. In the illustrated embodiment, precursor gas (or gases) may be introduced to a vacuum evacuated dielectric discharge tube 11. The discharge tube 11 includes an electrode configuration 13 that is attached to a variable frequency RF amplifier 10. The other portion of the electrode 14 is either grounded, DC biased, or operated in a push-pull manner relative to electrode 13. The electrodes 13, 14 are used to couple the very high frequency (VHF) power into the precursor gas (or gases) to ignite and sustain a glow discharge or plasma 12. The precursor gas (or gases) may then be disassociated in the plasma and nucleate to form nanoparticles.

In one embodiment, the electrodes 13, 14 for a plasma source inside the dielectric tube 11 that is a flow-through showerhead design in which a VHF radio frequency biased upstream porous electrode plate 13 is separated from a down stream porous electrode plate 14, with the pores of the plates aligned with one another. The pores could be circular, rectangular, or any other desirable shape. Alternatively, the dielectric tube 11 may enclose an electrode 13 that is coupled to the VHF radio frequency power source 10 and has a pointed tip that has a variable distance between the tip and a grounded ring 14 inside the dielectric tube 11. In this case, the VHF radio frequency power source 10 operates in a frequency range of about 10 to 500 MHz. In another alternative embodiment, the pointed tip 13 can be positioned at a variable distance between the tip and a VHF radio frequency powered ring 14 operated in a push-pull mode (180° out of phase). In yet another alternative embodiment, the electrodes 13, 14 include an inductive coil coupled to the VHF radio frequency power source so that radio frequency power is delivered to the precursor gas (or gases) by an electric field formed by the inductive coil. Portions of the dielectric tube 11 can be evacuated to a vacuum level between 1×10⁻⁷ to 500 Torr.

The nucleated nanoparticles may pass into a larger vacuum evacuated reactor 15, where collection on a solid substrate 16 (including a chuck) or into an appropriate liquid substrate/solution can occur. For example, the nanoparticles may be collected in a capture fluid and subsequently combined with the precursor compound to form the composition. The solid substrate 16 can be electrically grounded, biased, temperature controlled, rotating, positioned relative the electrodes producing the nanoparticles, or on a roll-to-roll system. If deposition onto substrates is not the choice, then the particles are evacuated into a suitable pump for transition to atmospheric pressure. The nanoparticles can then be sent to an atmospheric classification system, such as a differential mobility analyzer, and collected for further functionalization or other processing.

In the illustrated embodiment, the plasma is initiated with a high frequency plasma via an RF power amplifier such as an AR Worldwide Model KAA2040 or an Electronics and Innovation 3200L. The amplifier can be driven (or pulsed) by an arbitrary function generator (e.g., a Tektronix AFG3252 function generator) that is capable of producing up to 200 watts of power from 0.15 to 150 MHz. In various embodiments, the arbitrary function may be able to drive the power amplifier with pulse trains, amplitude modulation, frequency modulation, or different waveforms. The power coupling between the amplifier and the precursor gas typically increases as the frequency of the RF power increases. The ability to drive the power at a higher frequency may therefore allow more efficient coupling between the power supply and discharge.

If desired, nanoparticles having varying agglomeration lengths can be produced by nucleating the nanoparticles from at least one precursor gas in a VHF radio frequency low pressure plasma discharge and collecting the nucleated nanoparticles by controlling the mean free path of the nanoparticles as an aerosol, thus allowing particle—particle interactions prior to collection. The nucleated nanoparticles may be collected on a solid substrate within a vacuum environment where the collection distance is greater than the mean free path of the particles controlled via the pressure. The agglomeration lengths of the nanoparticles can thereby be controlled. Alternatively, the nucleated nanoparticles may be collected in a liquid substrate within a vacuum environment where the collection distance is greater than the mean free path of the particles controlled via the pressure thus controlling the agglomeration lengths of the nanoparticles. The further away the substrate is from the nucleation region (plasma discharge), the longer the agglomerations are at a constant pressure. The synthesized nanoparticles may be evacuated out of the low pressure environment into an atmospheric environment as an aerosol so that the agglomeration length is at least partially controlled by the concentration of the aerosol.

In certain embodiments, nanoparticles can be produced by synthesizing crystalline or amorphous core nanoparticles using VHF radio frequency low pressure plasma that is discharged in a low pressure environment by pulsing the discharge to control the plasma residence time. For example, the amorphous core nanoparticles can be synthesized at increased plasma residence time relative to the precursor gas molecular residence time through a VHF radio frequency low pressure plasma discharge. Alternatively, crystalline core nanoparticles can be synthesized at lower plasma residence times at the same operating conditions of discharge drive frequency, drive amplitude, discharge tube pressure, chamber pressure, plasma power density, gas molecule residence time through the plasma, and collection distance from plasma source electrodes.

Additional aspects relating to this particular embodiment in which the nanoparticles are produced via this plasma process are described in International (PCT) Publication No. WO 2010/027959 (PCT/US2009/055587), which is incorporate by reference herein in its entirety.

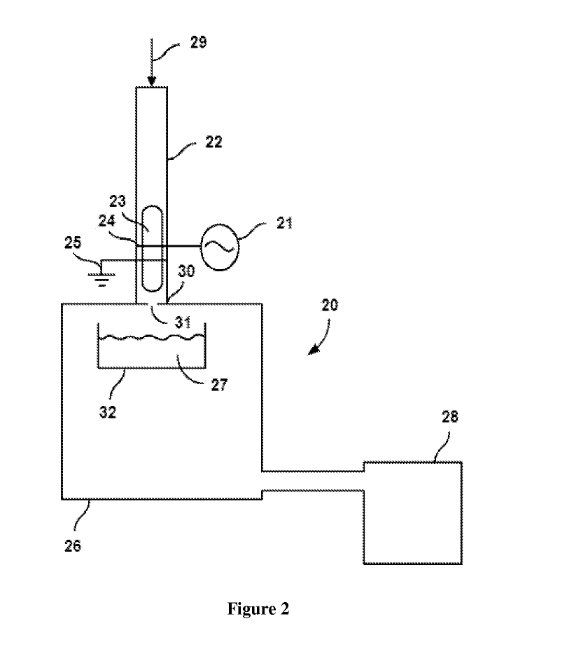

Referring to FIG. 2, an alternative embodiment of a plasma reactor system is shown at 20. In this embodiment, the plasma reactor system 20 comprises a plasma generating chamber 22 having a reactant gas inlet 29 and an outlet 30 having an aperture or orifice 31 therein. A particle collection chamber 26 is in communication with the plasma generating chamber 22. The particle collection chamber 26 contains a capture fluid 27 in a container 32. The container 32 may be adapted to be agitated (by means not shown). For example, the container 32 may be positioned on a rotatable support (not shown) or may include a stirring mechanism. Preferably the capture fluid is a liquid at the temperatures of operation of the system. The plasma reactor system 5 also includes a vacuum source 28 in communication with the particle collection chamber 26 and plasma generating chamber 22.

The plasma generating chamber 22 comprises an electrode configuration 24 that is attached to a variable frequency RF amplifier 21. The plasma generating chamber 22 also comprises a second electrode configuration 25. The second electrode configuration 25 is either ground, DC biased, or operated in a push-pull manner relative to the electrode configuration 24. The electrodes 24, 25 are used to couple the very high frequency (VHF) power to the reactant gas mixture to ignite and sustain a glow discharge of plasma within the area identified as 23. The first reactive precursor gas (or gases) is then dissociated in the plasma to provide charged atoms which nucleate to form nanoparticles. However, other discharge tube configurations are contemplated, and may be used in carrying out the method disclosed herein.

In the embodiment of FIG. 2, the nanoparticles are collected in the particle collection chamber 26 in the capture fluid. To control the diameter of the nanoparticles which are formed, the distance between the aperture 31 in the outlet 22 of plasma generating chamber 22 and the surface of the capture fluid ranges between about 5 to about 50 aperture diameters. It has been found that positioning the surface of the capture fluid too close to the outlet of the plasma generating chamber may result in undesirable interactions of plasma with the capture fluid. Conversely, positioning the surface of the capture fluid too far from the aperture reduces particle collection efficiency. As collection distance is a function of the aperture diameter of the outlet and the pressure drop between the plasma generating chamber and the collection chamber, based on the operating condition described herein, an acceptable collection distance is from about 1 to about 20, alternatively from about 5 to about 10, cm. Said differently, an acceptable collection distance is from about 5 to about 50 aperture diameters.

The plasma generating chamber 22 also comprises a power supply. The power is supplied via a variable frequency radio frequency power amplifier 21 that is triggered by an arbitrary function generator to establish high frequency pulsed plasma in area 23. Preferably, the radiofrequency power is capacitively coupled into the plasma using a ring electrode, parallel plates, or an anode/cathode setup in the gas. Alternatively, the radiofrequency power may be inductively coupled mode into the plasma using an RF coil setup around the discharge tube.

The plasma generating chamber 11 may also comprise a dielectric discharge tube. Preferably, a reactant gas mixture enters the dielectric discharge tube where the plasma is generated. Nanoparticles which form from the reactant gas mixture start to nucleate as the first reactive precursor gas molecules are dissociated in the plasma.

The vacuum source 28 may comprise a vacuum pump. Alternatively, the vacuum source 28 may comprise a mechanical, turbo molecular, or cryogenic pump.

In one embodiment, the electrodes 24, 25 for a plasma source inside the plasma generating chamber 22 comprise a flow-through showerhead design in which a VHF radio frequency biased upstream porous electrode plate 24 is separated from a down stream porous electrode plate 25, with the pores of the plates aligned with one another. The pores may be circular, rectangular, or any other desirable shape. Alternatively, the plasma generating chamber 22 may enclose an electrode 24 that is coupled to the VHF radio frequency power source and has a pointed tip that has a variable distance between the tip and a grounded ring inside the chamber 22.

In one embodiment, the VHF radio frequency power source may be operated in a manner substantially similar to that described above with respect to the embodiment of FIG. 1. The plasma in area 23 may be initiated with a high frequency plasma via an RF power amplifier such as an AR Worldwide Model KAA2040, or an Electronics and Innovation Model 3200L, or an EM Power RF Systems, Inc. Model BBS2E3KUT. The amplifier can be driven (or pulsed) by an arbitrary function generator, as described above relative to the embodiment of FIG. 1.

In one embodiment, the power and frequency of the plasma system is preselected to create an optimal operating space for the formation of the nanoparticles. Preferably, tuning both the power and frequency creates an appropriate ion and electron energy distribution in the discharge to help dissociate the molecules of the reactive precursor gas and nucleate the nanoparticles.

The plasma reactor system 20 illustrated in FIG. 2 may be pulsed to enable an operator to directly manage the resident time for particle nucleation, and thereby control the particle size distribution and agglomeration kinetics in the plasma. The pulsing function of the system 20 allows for controlled tuning of the particle resident time in the plasma, which affects the size of the nanoparticles. By decreasing the “on” time of the plasma, the nucleating particles have less time to agglomerate, and therefore the size of the nanoparticles may be reduced on average (i.e., the nanoparticle distribution may be shifted to smaller diameter particle sizes).

Advantageously, the operation of the plasma reactor system 20 at higher frequency ranges and pulsing the plasma provides the same conditions as in conventional constricted/filament discharge techniques that use a plasma instability to produce the high ion energies/densities, but with the additional advantage that users can control operating conditions to select and produce nanoparticles having various sizes, which impacts their characteristic physical properties, e.g. photoluminescence.

For a pulse injection, the synthesis of the nanoparticles can be done with a pulsed energy source, such as a pulsed very high frequency RF plasma, a high frequency RF plasma, or a pulsed laser for pyrolysis. Preferably, the VHF radiofrequency is pulsed at a frequency ranging from about 1 to about 50 kHz.

Another method to transfer the nanoparticles to the capture fluid is to pulse the input of the reactant gas mixture while the plasma is ignited. For example, one could ignite the plasma in which a first reactive precursor gas is present to synthesize the nanoparticles, with at least one other gas present to sustain the discharge, such as an inert gas. The nanoparticle synthesis is stopped when the flow of first reactive precursor gas is stopped with a mass flow controller. The synthesis of the nanoparticles continues when the flow of the first reactive precursor gas is started again. This produces a pulsed stream of nanoparticles. This technique can be used to increase the concentration of nanoparticles in the capture fluid if the flux of nanoparticles impinging on the capture fluid is greater than the absorption rate of the nanoparticles into the capture fluid.

In another embodiment, the nucleated nanoparticles are transferred from the plasma generating chamber 22 to particle collection chamber 26 containing capture fluid via the aperture or orifice 31 which creates a pressure differential. It is contemplated that the pressure differential between the plasma generating chamber 22 and the particle collection chamber 26 can be controlled through a variety of ways. In one configuration, the discharge tube inside diameter of the plasma generating chamber 22 is much less than the inside diameter of the particle collection chamber 26, thus creating a pressure drop. In another configuration, a grounded physical aperture or orifice may be placed between the discharge tube and the collection chamber 26 that forces the plasma to reside partially inside the orifice, based on the Debye length of the plasma and the size of the chamber 22. Another configuration comprises using a varying electrostatic orifice in which a positive concentric charge is developed that forces the negatively charged plasma through the aperture 31.

It is contemplated that the capture fluid may be used as a material handling and storage medium. In one embodiment, the capture fluid is selected to allow nanoparticles to be absorbed and disperse into the fluid as they are collected, thus forming a dispersion or suspension of nanoparticles in the capture fluid. Nanoparticles will be adsorbed into the fluid if they are miscible with the fluid. For example, the nanoparticles may be collected in a capture fluid and subsequently combined with the precursor compound so as to form the composition.

The capture fluid is selected to have the desired properties for nanoparticle capture and storage. In a specific embodiment, the vapor pressure of the capture fluid is lower than the operating pressure in the plasma reactor. Preferably, the operating pressure in the reactor and collection chamber 26 range from about 1 to about 5 mTorr. Other operating pressures are also contemplated. The capture fluid may comprise a silicone fluid such as polydimethylsiloxane, phenylmethyl-dimethyl cyclosiloxane, tetramethyltetraphenyltrisiloxane, and/or pentaphenyltrimethyltrisiloxane.

The capture fluid may be agitated during the direct capture of the nanoparticles, e.g. by stirring, rotation, inversion, and other suitable methods of providing agitation. If higher absorption rates of the nanoparticles into the capture liquid are desired, more intense forms of agitation are contemplated, e.g. ultrasonication.

As first introduced above, in the embodiment of FIG. 2, upon the dissociation of the first reactive precursor gas in the plasma generation chamber 22, nanoparticles form and are entrained in the gas phase. The distance between the nanoparticle synthesis location and the surface of capture fluid must be short enough so that no unwanted functionalization occurs while the nanoparticles are entrained. If the nanoparticles interact within the gas phase, agglomerations of numerous individual small nanoparticles will form and be captured in the capture fluid. If too much interaction takes place within the gas phase, the nanoparticles may sinter together and form nanoparticles having larger average diameters. The collection distance is defined as the distance from the outlet of the plasma generating chamber to the surface of the capture fluid.

Additional aspects relating to this particular embodiment in which the nanoparticles are produced via this plasma process are described in International (PCT) Publication No. WO 2011/109299 (PCT/US2011/026491), which is incorporated by reference herein in its entirety.

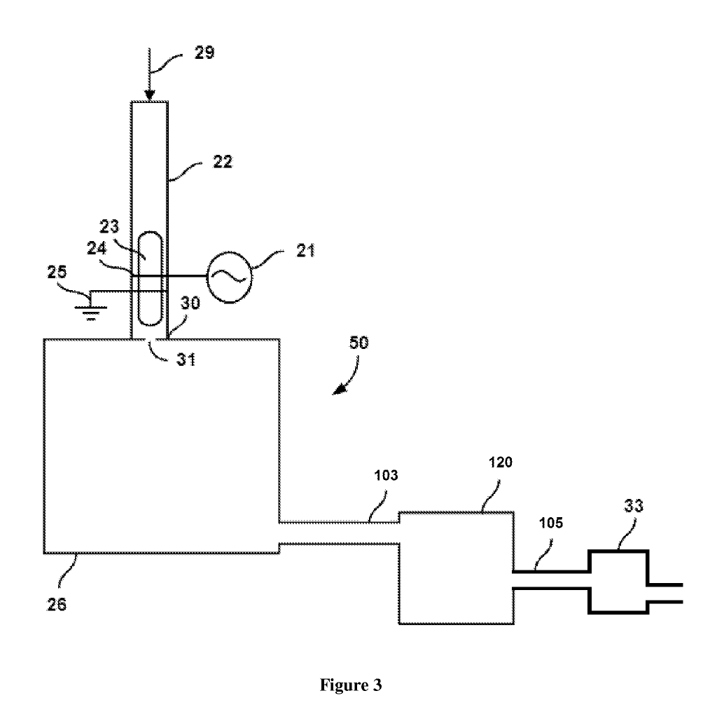

Referring to FIG. 3, an alternative embodiment of a plasma reactor system is shown at 50. In this embodiment, the nanoparticles of the composition are prepared in a system having a reactor for producing a nanoparticle aerosol (e.g., nanoparticles in a gas) and a diffusion pump in fluid communication with the reactor for collecting the nanoparticles of the aerosol. For example, nanoparticles of various size distributions and properties can be prepared by introducing a nanoparticle aerosol produced in a reactor (e.g. a low-pressure plasma reactor) into a diffusion pump in fluid communication with the reactor, capturing the nanoparticles of the aerosol in a condensate from a diffusion pump oil, liquid, or fluid (e.g. silicone fluid), and collecting the captured nanoparticles in a reservoir.

Example reactors are described in WO 2010/027959 and WO 2011/109229, each of which is described above and incorporated by reference in its entirety herein. Such reactors can be, but are not limited to, low pressure high frequency pulsed plasma reactors. For example, FIG. 3 illustrates the plasma reactor of the embodiment of FIG. 2, but includes the diffusion pump in fluid communication with the reactor. To this end, description relative to this particular plasma reactor is not repeated herein with respect to the embodiment of FIG. 3.

In the embodiment of FIG. 3, the plasma reactor system 50 includes a diffusion pump 120. As such, the nanoparticles can be collected by the diffusion pump 120. A particle collection chamber 26 may be in fluid communication with the plasma generating chamber 22. The diffusion pump 120 may be in fluid communication with the particle collection chamber 26 and the plasma generating chamber 22. In other forms of the present disclosure, the system 50 may not include the particle collection chamber 26. For example, the outlet 30 may be coupled to an inlet 103 of the diffusion pump 120, or the diffusion pump 120 may be in substantially direct fluid communication with the plasma generating chamber 22.

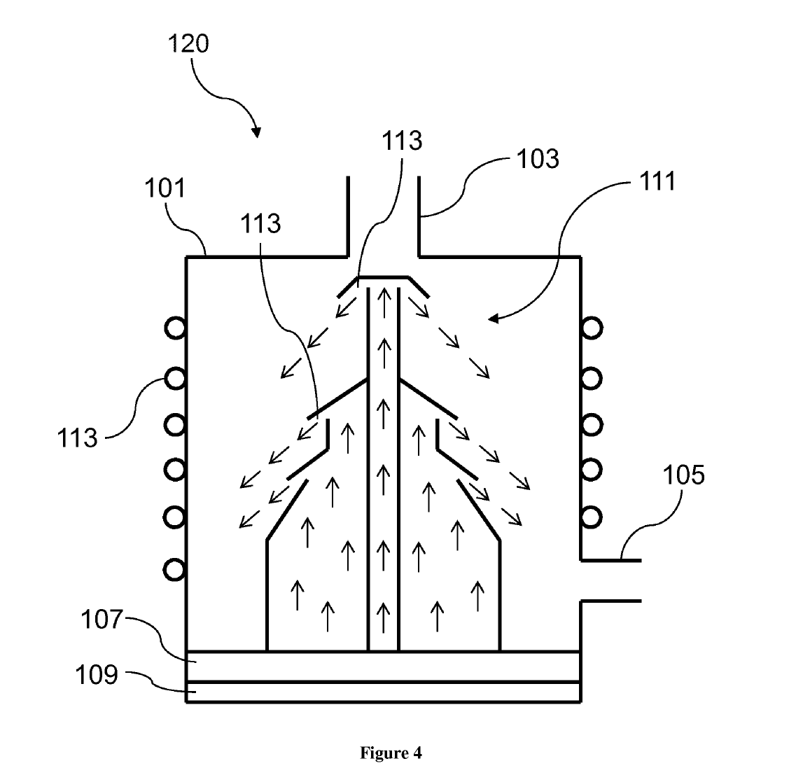

FIG. 4 is a cross-sectional schematic of an example diffusion pump 120 suitable for the system 50 of the embodiment of FIG. 3. The diffusion pump 120 can include a chamber 101 having an inlet 103 and an outlet 105. The inlet 103 may have a diameter of about 2 to about 55 inches, and the outlet may have a diameter of about 0.5 to about 8 inches. The inlet 103 of the chamber 101 is in fluid communication with the outlet 30 of the reactor 20. The diffusion pump 120 may have, for example, a pumping speed of about 65 to about 65,000 liters/second or greater than about 65,000 liters/second.

The diffusion pump 120 includes a reservoir 107 in fluid communication with the chamber 101. The reservoir 107 supports or contains a diffusion pump fluid. The reservoir may have a volume of about 30 cc to about 15 liters. The volume of diffusion pump fluid in the diffusion pump may be about 30 cc to about 15 liters.

The diffusion pump 120 can further include a heater 109 for vaporizing the diffusion pump fluid in the reservoir 107 to a vapor. The heater 109 heats up the diffusion pump fluid and vaporizes the diffusion pump fluid to form a vapor (e.g., liquid to gas phase transformation). For example, the diffusion pump fluid may be heated to about 100 to about 400° C. or about 180 to about 250° C.

A jet assembly 111 can be in fluid communication with the reservoir 107 comprising a nozzle 113 for discharging the vaporized diffusion pump fluid into the chamber 101. The vaporized diffusion pump fluid flows and rises up though the jet assembly 111 and emitted out the nozzles 113. The flow of the vaporized diffusion pump fluid is illustrated in FIG. 4 with arrows. The vaporized diffusion pump fluid condenses and flows back to the reservoir 107. For example, the nozzle 113 can discharge the vaporized diffusion pump fluid against a wall of the chamber 101. The walls of the chamber 101 may be cooled with a cooling system 113 such as a water cooled system. The cooled walls of the chamber 101 can cause the vaporized diffusion pump fluid to condense. The condensed diffusion pump fluid can then flow along and down the walls of the chamber 101 and back to the reservoir 107. The diffusion pump fluid can be continuously cycled through diffusion pump 120. The flow of the diffusion pump fluid causes gas that enters the inlet 103 to diffuse from the inlet 103 to the outlet 105 of the chamber 101. A vacuum source 33 may be in fluid communication with the outlet 105 of the chamber 101 to assist removal of the gas from the outlet 105.

As the gas flows through the chamber 101, nanoparticles in the gas can be absorbed by the diffusion pump fluid, thereby collecting the nanoparticles from the gas. For example, a surface of the nanoparticles may be wetted by the vaporized and/or condensed diffusion pump fluid. Furthermore, the agitating of cycled diffusion pump fluid may further improve absorption rate of the nanoparticles compared to a static fluid. The pressure within the chamber 101 may be less than about 1 mTorr.

The diffusion pump fluid with the nanoparticles can then be removed from the diffusion pump 120. For example, the diffusion pump fluid with the nanoparticles may be continuously removed and replaced with diffusion pump fluid that substantially does not have nanoparticles.

Advantageously, the diffusion pump 120 can be used not only for collecting nanoparticles but also evacuating the reactor 20 (and collection chamber 26). For example, the operating pressure in the reactor 20 can be a low pressure, e.g. less than atmospheric pressure, less than 760 Torr, or between about 1 and about 760 Torr. The collection chamber 26 can, for example, range from about 1 to about 5 mTorr. Other operating pressures are also contemplated.

The diffusion pump fluid can be selected to have the desired properties for nanoparticle capture and storage. The diffusion pump fluid may be the same as the capture fluid described above relative to the embodiment of FIG. 2. The nanoparticles may be separated or isolated from the diffusion pump fluid prior to incorporation into the composition. For example, the diffusion pump fluid may be centrifuged and/or decanted to concentrate or isolate the nanoparticles therein. Other diffusion pump fluids and oils may include hydrocarbons, phenyl ethers, fluorinated polyphenyl ethers, and ionic fluids. The fluid may have a viscosity of from 0.001 to 1.0, from 0.005 to 0.50, or from 0.01 to 0.10, Pas at 23±3° C. Furthermore, the fluid may have a vapor pressure of less than about 1×10⁻⁴ Torr.

The system 50 may also include a vacuum pump or vacuum source 33 in fluid communication with the outlet 105 of the diffusion pump 120. The vacuum source 33 can be selected in order for the diffusion pump 120 to operate properly. In one form of the present disclosure, the vacuum source 33 comprises a vacuum pump (e.g., auxiliary pump). The vacuum source 33 may comprise a mechanical, turbo molecular, or cryogenic pump. However, other vacuum sources are also contemplated.

One method of producing nanoparticles with the system 50 of FIG. 3 can include forming a nanoparticle aerosol in the reactor 20. The nanoparticle aerosol can comprise nanoparticles in a gas, and the method further includes introducing the nanoparticle aerosol into the diffusion pump 120 from the reactor 5. The method also may include heating the diffusion pump fluid in a reservoir 107 to form a vapor, sending the vapor through a jet assembly 111, emitting the vapor through a nozzle 113 into a chamber 101 of the diffusion pump 120, condensing the vapor to form a condensate, and flowing the condensate back to the reservoir 107. Furthermore, the method can further include capturing the nanoparticles of the aerosol in the condensate and collecting the captured nanoparticles in the reservoir 107. The method can further include removing the gas from the diffusion pump with a vacuum pump.

Regardless of the particular plasma system and process utilized to produce the nanoparticles of the composition, the plasma system generally relies on a precursor gas, as introduced above in the various embodiments. The precursor gas may alternatively be referred to as a reactant gas mixture or a gas mixture. The precursor gas is generally selected based on a desired composition of the nanoparticles, as described in greater detail below with reference to the nanoparticles. For example, when the nanoparticles comprise silicon nanoparticles, the precursor gas may contain silicon, and when the nanoparticles comprise germanium, the precursor gas may contain germanium. Furthermore, the precursor gas may be selected from silanes, disilanes, halogen-substituted silanes, halogen-substituted disilanes, C₁-C₄ alkyl silanes, C₁-C₄ alkyldisilanes, and mixtures thereof. In one form of the present disclosure, precursor gas may comprise silane which comprises from about 0.1 to about 2% of the total gas mixture. However, the gas mixture may also comprise other percentages of silane and/or additional or alternative precursor gasses, as described below with reference to the nanoparticles formed therefrom.

The precursor gas may be mixed with other gases such as inert gases to form a gas mixture. Examples of inert gases that may be included in the gas mixture include argon, xenon, neon, or a mixture of inert gases. When present in the gas mixture, the inert gas may comprise from about 1% to about 99% of the total volume of the gas mixture. The precursor gas may have from about 0.1% to about 50% of the total volume of the gas mixture. However, it is also contemplated that the precursor gas may comprise other volume percentages such as from about 1% to about 50% of the total volume of the gas mixture.

In one form of the present disclosure, the reactant gas mixture also comprises a second precursor gas which itself can comprise from about 0.1 to about 49.9 volume % of the reactant gas mixture. The second precursor gas may comprise BCl₃, B₂H₆, PH₃, GeH₄, or GeCl₄. The second precursor gas may also comprise other gases that contain carbon, germanium, boron, phosphorous, or nitrogen. The combination of the first precursor gas and the second precursor gas together may make up from about 0.1 to about 50% of the total volume of the reactant gas mixture.

In another form of the present disclosure, the reactant gas mixture further comprises hydrogen gas. Hydrogen gas can be present in an amount of from about 1% to about 10% of the total volume of the reactant gas mixture. However, it is also contemplated that the reactant gas mixture may comprise other percentages of hydrogen gas.

Nanoparticles for the composition can be prepared by any of the methods described above. Contingent on the precursor gas and molecules utilized in the plasma process, nanoparticles of various composition may be produced. For example, the nanoparticles may be semiconducting nanoparticles comprising at least one element selected from Group IV, Group IV-IV, Group II-IV, and Group III-V. Alternatively, the nanoparticles may be metal nanoparticles comprising at least one element selected from Group IIA, Group IIIA, Group IVA, Group VA, Group IB, Group IIB, Group IVB, Group VB, Group VIB, Group VIIB, and Group VIIIB metals. These Group designations of the periodic table are generally from the CAS or old IUPAC nomenclature, although Group IV elements are referred to as group 14 elements under the modern IUPAC system, as readily understood in the art. Alternatively still, the nanoparticles may be metal alloy nanoparticles, metal oxide nanoparticles, metal nitride nanoparticles, ceramic nanoparticles, etc.

The processes provided herein are particularly well-suited for use in the production of nanoparticles that are single-crystal and comprise Group IV semiconductors, including silicon, germanium and tin, from precursor molecules containing these elements. Silane and germane are examples of precursor molecules that may be used in the production of nanoparticles comprising silicon and germanium, respectively. Organometallic precursor molecules may also be used. These molecules include a Group IV metal and organic groups. Organometallic Group IV precursors include, but are not limited to organosilicon, organogermanium and organotin compounds. Some examples of Group IV precursors include, but are not limited to, alkylgermaniums, alkylsilanes, alkylstannanes, chlorosilanes, chlorogermaniums, chlorostannanes, aromatic silanes, aromatic germaniums and aromatic stannanes. Other examples of silicon precursors include, but are not limited to, disilane (Si₂H₆), silicon tetrachloride (SiCl₄), trichlorosilane (HSiCl₃) and dichlorosilane (H₂SiCl₂). Still other suitable precursor molecules for use in forming crystalline silicon nanoparticles include alkyl and aromatic silanes, such as dimethylsilane (H₃C—SiH₂—CH₃), tetraethyl silane ((CH₃CH₂)₄Si) and diphenylsilane (Ph-SiH₂—Ph). In addition to germane, particular examples of germanium precursor molecules that may be used to form crystalline Ge nanoparticles include, but are not limited to, germanium tetrachloride (GeCl₄), tetraethyl germane ((CH₃CH₂)₄Ge) and diphenylgermane (Ph-GeH₂—Ph).

In certain embodiments, the nanoparticles comprise at least one of silicon and germanium. Further, the nanoparticles may comprise silicon alloys and/or germanium alloys. Silicon alloys that may be formed include, but are not limited to, silicon carbide, silicon germanium, silicon boron, silicon phosphorous, and silicon nitride. The silicon alloys may be formed by mixing at least one first precursor gas with the second precursor gas or using a precursor gas that contains the different elements. However, other methods of forming alloyed nanoparticles are also contemplated.

In another form of the present disclosure, the nanoparticles may undergo an additional doping step. For example, the nanoparticles may undergo gas phase doping in the plasma, where a second precursor gas is dissociated and is incorporated in the nanoparticles as they are nucleated. The nanoparticles may also undergo doping in the gas phase downstream of the production of the nanoparticles, but before the nanoparticles are captured in the liquid. Furthermore, doped nanoparticles may also be produced in the diffusion pump fluid where the dopant is preloaded into the diffusion pump fluid and interacts with the nanoparticles after they are captured. Doped nanoparticles can be formed by contact with organosilicon gases or liquids, including, but not limited to trimethylsilane, disilane, and trisilane. Gas phase dopants may include, but are not limited to, BCl₃, B₂H₆, PH₃, GeH₄, or GeCl₄.

The nanoparticles may exhibit a number of unique electronic, magnetic, catalytic, physical, optoelectronic and optical properties due to quantum confinement effects. For example, many semiconductor nanoparticles exhibit photoluminescence effects that are significantly greater than the photoluminescence effects of macroscopic materials having the same composition.

The nanoparticles may have a largest dimension or average largest dimension less than 50, less than 20, less than 10, or less than 5, nm. Furthermore, the largest dimension or average largest dimension of the nanoparticles may be between 1 and 50, between 2 and 50, between 2 and 20, between 2 and 10, or between about 2.2 and about 4.7, nm. The nanoparticles can be measured by a variety of methods, such as with a transmission electron microscope (TEM). For example, as understood in the art, particle size distributions are often calculated via TEM image analysis of hundreds of different nanoparticles. In various embodiments, the nanoparticles may comprise quantum dots, typically silicon quantum dots. Quantum dots have excitons confined in all three spatial dimensions and may comprise individual crystals, i.e., each quantum dot is a single crystal.

In various embodiments, the nanoparticles may be photoluminescent when excited by exposure to UV light. Depending on the average diameter of the nanoparticles, they may photoluminescence in any of the wavelengths in the visible spectrum and may visually appear to be red, orange, green, blue, violet, or any other color in the visible spectrum. For example, nanoparticles with an average diameter less than about 5 nm may produce visible photoluminescence, and nanoparticles with an average diameter less than about 10 nm may produce near infrared (IR) luminescence. In one form of the present disclosure, the photoluminescent silicon nanoparticles have a photoluminescent intensity of at least 1×10⁶ at an excitation wavelength of about 365 nm. The photoluminescent intensity may be measured with a Fluorolog3 spectrofluorometer (commercially available from Horiba of Edison, N.J.) with a 450 W Xe excitation source, excitation monochromator, sample holder, edge band filter (400 nm), emission monochromator, and a silicon detector photomultiplier tube. To measure photoluminescent intensity, the excitation and emission slit width are set to 2 nm and the integration time is set to 0.1 s. In these or other embodiments, the photoluminescent silicon nanoparticles may have a quantum efficiency of at least 4% at an excitation wavelength of about 395 nm as measured on an HR400 spectrophotometer (commercially available from Ocean Optics of Dunedin, Fla.) via a 1000 micron optical fiber coupled to an integrating sphere and the spectrophotometer with an absorption of >10% of the incident photons. Quantum efficiency was calculated by placing a sample into the integrating sphere and exciting the sample via a 395 nm LED driven by an Ocean Optics LED driver. The system was calibrated with a known lamp source to measure absolute irradiance from the integrating sphere. The quantum efficiency was then calculated by the ratio of total photons emitted by the nanoparticles to the total photons absorbed by the nanoparticles. Further, in these or other embodiments, the nanoparticles may have a full width at half maximum emission of from 20 to 250 at an excitation wavelength of 270-500 nm.

Furthermore, both the photoluminescent intensity and luminescent quantum efficiency may continue to increase over time when the nanoparticles (optionally in the composition, capture fluid, or diffusion pump fluid) are exposed to air. In another form of the present disclosure, the maximum emission wavelength of the nanoparticles shifts to shorter wavelengths over time when exposed to oxygen. The luminescent quantum efficiency of the directly captured silicon nanoparticle composition may be increased by about 200% to about 2500% upon exposure to oxygen. However, other increases in the luminescent quantum efficiency are also contemplated. The photoluminescent intensity may increase from 400 to 4500% depending on the time exposure to oxygen and the concentration of the nanoparticles in the fluid. However, other increases in the photoluminescent intensity are also contemplated. The wavelength emitted from the direct capture composition also experiences a blue shift of the emission spectrum. In one form of the present disclosure, the maximum emission wavelength shifts about 100 nm, based on about a 1 nm decrease in nanoparticle core size, depending on the time exposed to oxygen. However, other maximum emission wavelength shifts are also contemplated.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The following examples are intended to illustrate the invention and are not to be viewed in any way as limiting to the scope of the invention.

### EXAMPLES

Composite articles are formed in accordance with the disclosure. In particular, compositions are prepared which comprise a precursor compound and nanoparticles produced via a plasma process. The composite articles are formed from the compositions.

### Preparation Example 1

### Nanoparticle Production

Nanoparticles are produced via a plasma process for incorporation into the composition. In particular, the nanoparticles are produced via the plasma process exemplified above via the embodiment of FIG. 3 including the diffusion pump.

In particular, 90 sccm Ar, 17 sccm SiH₄ (2% vol. in Ar), and 6 sccm H₂ gas are delivered to the reactor via mass flow controllers. The reactor has a base pressure of less than 2×10⁻⁸ Torr.

15 mL of diffusion pump fluid (polydimethylsiloxane) is disposed into the chamber of the reactor at an operating pressure of 1×10⁻⁴ Torr, rotating at 15 rpm.

The reactor operates at 120 W coupled plasma power at 127 MHZ in the discharge tube at 3.5 Torr.

Nanoparticles are synthesized and injected into the diffusion pump fluid located about 5 cm downstream from the orifice. The nanoparticles are produced at a rate of about 0.01 wt % Si nanoparticles per 5 minutes.

The nanoparticles are removed from the reactor along with the diffusion pump fluid and transferred to a glass vial that was sealed under nitrogen. The vial is sonicated for one hour to disperse the nanoparticles in the diffusion pump fluid to form a suspension.

### Practical Example 1

60 mg of hexadecyltrimethylammonium chloride (commercially available under the tradename Arquad® 16-29 from AkzoNobel Surface Chemistry LLC of Chicago, Ill.; 29% (w/w) aqueous solution) and 20 mg of tetra(ethylene oxide) lauryl ether (commercially available under the tradename Brij® 30 from Spectrum Laboratory Products, Inc. of New Brunswick, N.J.) are combined along with 13.8 mL water in a flask. The contents of the flask are mixed until homogenous. A sample of the suspension formed in Preparation Example 1 (4 mg; 0.1% (w/w)) is disposed into the flask. The contents of the flask are sonicated for one minute to disperse the nanoparticles. 2.09 grams of a tetraethylorthosilicate, i.e., a precursor compound, are disposed in the flask while stirring to form a composition. The composition is stirred at room temperature for one hour and allowed to stand without stirring at room temperature for about 24 hours. The composition is cooled to −50° C. and the water is removed by freeze-drying. A composite article in the form of a white powder having an average particle size of from 1 to 5 μm is obtained. The composite article has a host matrix comprising SiO₄₁₂ units. The powder exhibits bright orange photoluminescence when exposed to UV or blue radiation.

### Preparation Example 2

### Nanoparticle Production

Nanoparticles are produced via a plasma process for incorporation into the composition. In particular, the nanoparticles are produced via the plasma process exemplified above via the embodiment of FIG. 3 including the diffusion pump.

In particular, 90 sccm Ar, 17 sccm SiH₄ (2% vol. in Ar), and 6 sccm H₂ gas are delivered to the reactor via mass flow controllers. The reactor has a base pressure of less than 2×10⁻⁸ Torr.

A diffusion pump fluid (commercially available under the tradename Dow Corning® 704 diffusion pump fluid from Dow Corning Corporation of Midland, Mich.) is disposed into the chamber of the reactor at an operating pressure of 1×10⁻⁴ Torr, rotating at 15 rpm.

The reactor operates at 120 W coupled plasma power at 127 MHZ in the discharge tube at 3.5 Torr.

Nanoparticles are synthesized and injected into the diffusion pump fluid located about 5 cm downstream from the orifice. The nanoparticles are produced at a rate of about 0.01 wt % Si nanoparticles per 5 minutes.

The nanoparticles are removed from the reactor along with the diffusion pump fluid in the form of a suspension and transferred to a glass vial. The nanoparticles and the diffusion pump fluid are aged at 85° C.

### Practical Example 2

The suspension of Preparation Example 1 is transferred to a centrifuge vial and spun at 4,000 rot/min for 2 hours to concentrate the nanoparticles. After centrifuging, the top fluid (i.e., the diffusion pump fluid) is removed by decanting and discarded. The packed solid (which comprises the nanoparticles) is washed by repeated suspension in toluene and subsequent centrifugation. 2 mL of a hydroxy-terminated hydrogen silsesquioxane resin, i.e., a precursor compound (commercially available under the tradename Fox® —16 flowable oxide from Dow Corning Corporation of Midland, Mich.), is added to the packed solids to form a composition. The composition is placed in a sonic bath for 15 minutes to disperse the nanoparticles therein. The composition is drop cast under a nitrogen environment onto a 1.25×1.25 inch quartz substrate to form an uncured film. The uncured film is heated on a hot plate set at 60° C. Solvent evaporates from the uncured film. After 30 minutes, the temperature is raised to 100° C., upon which some bubbling of the uncured film is observed. The temperature is increased by 100° C. every 15 minutes until the temperature reaches 400° C. Further bubbling and cracking is observed. After heating at 400° C. for 45 minutes, the temperature is reduced by 100° C. every 20 minutes. The heat is turned off once the temperature is below 100° C. The uncured film ultimately cured to form the composite article. At room temperature, the composite article had disintegrated into cracked pieces and foam solids. The composite article exhibits a strong red photoluminescence when exposed to UV radiation.

The invention has been described in an illustrative manner, and it is to be understood that the terminology which has been used is intended to be in the nature of words of description rather than of limitation. Obviously, many modifications and variations of the present invention are possible in light of the above teachings. The invention may be practiced otherwise than as specifically described.

What is claimed is:

1. A method of preparing a composite article, said method comprising:
combining a precursor compound and nanoparticles produced via a plasma process to form a composition; and
forming the composite article from the composition;
wherein the composite article comprises a host matrix comprising SiO_{4/2} units formed from the precursor compound with the nanoparticles being dispersed in the host matrix.

2. A method according to claim 1 wherein forming the composite article from the composition comprises reacting the precursor compound to form the host matrix.

3. A method according to claim 1 wherein the composite article consists essentially of the host matrix and the nanoparticles.

4. A method according to claim 1 wherein the host matrix has an Si/O ratio of at least 3/2.

5. A method according to claim 1 wherein the precursor compound has the general formula Si(OR)₄, wherein each R is an independently selected hydrocarbyl group having from 1 to 4 carbon atoms.

6. A method according to claim 5 wherein the composition further comprises water.

7. A method according to claim 1 wherein the precursor compound comprises a silsesquioxane resin.

8. A method according to claim 7 wherein the silsesquioxane resin comprises a hydrogen silsesquioxane resin.

9. A method according to claim 7 wherein the silsesquioxane resin is hydroxy-functional.

10. A method according to claim 7 wherein the composition further comprises a solvent.

11. A method according to claim 10 further comprising the step of removing the solvent from the composition during the step of forming the composite article from the composition.

12. A method according to claim 1 wherein the composite article is a solid.

13. A method according to claim 1 wherein the composite article is flowable.

14. A method according to claim 1 wherein the nanoparticles have an average largest dimension of from 1 to 50 nm.

15. A method according to claim 1 wherein the nanoparticles comprise at least one Group IV element.

16. A method according to claim 1 wherein the nanoparticles are photoluminescent.

17. A method according to claim 1 wherein the nanoparticles comprise quantum dots.

18. A composite article formed in accordance with the method of claim 1.

19. A composite article, comprising:
a host matrix comprising SiO_{4/2} units; and
nanoparticles dispersed in the host matrix, the nanoparticles being produced via a plasma process.

20. A composite article according to claim 19 wherein said host matrix has an Si/O ratio of at least 3/2.
